(19) United States
(12) Patent Application Publication
(10) Pub. No.: US 2009/0112884 A1
(43) Pub. Date: Apr. 30, 2009

(54) INFORMATION PROCESSING APPARATUS AND CONTROL METHOD

(75) Inventors: Anwar Sathath, Ome-shi (JP); Keiji Kanamori, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/261,955

(22) Filed: Oct. 30, 2008

(30) Foreign Application Priority Data
Oct. 31, 2007 (JP) 2007-284094

(51) Int. Cl. G06F 17/30

(52) U.S. Cl. 707/10; 707/E17.032

(57) ABSTRACT

According to one embodiment, an information processing apparatus includes a storage device, a first system configured to execute an information process, a second system configured to operate independently from the first system, and to execute a file server process, an activation control module configured to activate the first system in a first mode in which the storage device is used for the information process, and to activate the second system in a second mode in which the storage device is used for the file server process, and a switch circuit configured to connect the storage device to the first system in the first mode, and to connect the storage device to the second system in the second mode.

### CROSS-REFERENCE TO RELATED APPLICATIONS

This application is based upon and claims the benefit of priority from Japanese Patent Application No. 2007-284094, filed Oct. 31, 2007, the entire contents of which are incorporated herein by reference.

### BACKGROUND

1. Field

One embodiment of the invention relates to an information processing apparatus, such as a personal computer, which includes, for example, a storage device, and to a control method thereof.

2. Description of the Related Art

In recent years, various types of battery-powerable portable personal computers have been developed. Recently, large-capacity storage devices have begun to be mounted in portable personal computers, as well as in desktop personal computers and server computers.

Jpn. Pat. Appln. KOKAI Publication No. 2006-23887 discloses a system in which a digital versatile disc (DVD) drive and an external hard disk drive, for instance, are shared between a personal computer and a recorder for recording TV programs. In this system, the DVD drive and hard disk drive are mounted in a library card, and this library card is shared between the personal computer and the recorder.

In the meantime, in usual cases, most of operating systems, which are used in personal computers, have a function for file sharing. Thus, if the personal computer is connected to a network such as a LAN, and the file sharing function of the operating system is enabled, the storage device, such as a built-in hard disk drive, which is provided in the personal computer, can be used as a so-called network drive (also called “network storage”) which is accessible from devices on the network.

However, in this structure that makes use of the file sharing function of the operating system, even in the case where the storage device in the personal computer is used solely as the network drive, that is, even in the case where the personal computer is used solely as a dedicated file server, it is necessary to boot the operating system of the personal computer. In order to enable the operating system to run, it is necessary to operate almost all the devices in the personal computer. Consequently, much power is uselessly consumed.

Therefore, it is necessary to realize a novel function which can make it possible to use the storage device in the personal computer as a network drive, without causing useless power consumption.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing an example of the system configuration of an information processing apparatus according to an embodiment of the present invention;

FIG. 2 is an exemplary block diagram showing a structure example of a storage controller which is provided in the information processing apparatus according to the embodiment;

FIG. 3 is an exemplary block diagram for explaining the relationship between two modes, which are applied to the information processing apparatus according to the embodiment, and the states of two systems in the information processing apparatus;

FIG. 4 is an exemplary flow chart illustrating an example of an activation control process which is executed by the information processing apparatus according to the embodiment;

FIG. 5 is an exemplary flow chart illustrating another example of the activation control process which is executed by the information processing apparatus according to the embodiment;

FIG. 6 is an exemplary flow chart illustrating an example of the procedure of a setup process which is executed by the information processing apparatus according to the embodiment;

FIG. 7 shows an example of a setup screen which is displayed in the setup process illustrated in FIG. 6;

FIG. 8 shows an example of use of a memory space of a storage device which is provided in the information processing apparatus according to the embodiment;

FIG. 9 is an exemplary view for describing a file access process in a first mode (PC mode), which is executed by the information processing apparatus according to the embodiment;

FIG. 10 is an exemplary view for describing a file access process in a second mode (NAS mode), which is executed by the information processing apparatus according to the embodiment;

FIG. 11 is a block diagram for explaining the relationship between three modes, which are applied to the information processing apparatus according to the embodiment, and the states of the two systems in the information processing apparatus;

FIG. 12 is an exemplary perspective view showing an external appearance of the information processing apparatus according to the embodiment; and

FIG. 13 is a block diagram showing another example of the system configuration of the information processing apparatus according to the embodiment.

### DETAILED DESCRIPTION

Various embodiments according to the invention will be described hereinafter with reference to the accompanying drawings. In general, according to one embodiment of the invention, an information processing apparatus comprises a storage device, a first system configured to execute, under control of an operating system which manages each of files stored in the storage device, an information process which includes at least a process of executing an application program stored in the storage device, a process of executing communication with a network, and a process of accessing the storage device, a second system configured to operate independently from the first system, and to execute a file server process which manages each of the files stored in the storage device and executes write of a file in the storage device or read-out of a file from the storage device in accordance with a file access request which is sent from an external device via the network, an activation control module configured to activate the first system in a first mode in which the storage device is used for the information process, and to activate the second system in a second mode in which the storage device is used for the file server process, and a switch circuit configured to be disposed between each of the first system and the second system and the storage device, to connect the storage device to the first system in the first mode, and to connect the storage device to the second system in the second mode.

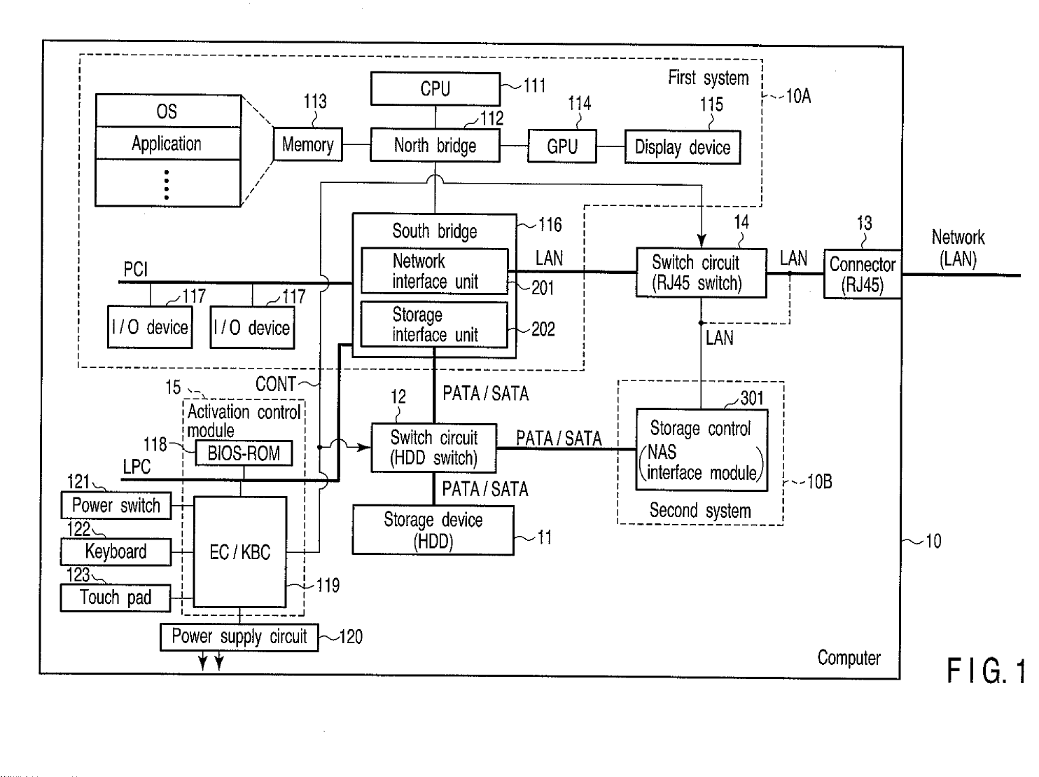

To begin with, referring to FIG. 1, the system configuration of an information processing apparatus according to an embodiment of the invention is described. The information processing apparatus according to the embodiment is realized, for example, as a battery-powerable notebook portable personal computer 10.

The computer 10 includes a first system 10A, a second system 10B, a storage device 11, a switch circuit 12, a network connector (LAN connector) 13, a switch circuit 14, and an activation control module 15.

The first system 10A is a main system which executes an operating system having a function of managing files stored in the storage device 11, and operates under the control of this operating system. Under the control of the operating system, the first system 10A executes an information process which includes at least a process of executing an application program stored in the storage device 11, a process of executing communication with a network such as a LAN, and a process of accessing the storage device 11. Although a specific structure example of the first system 10A will be described later, the first system 10A includes, in general terms, a processor, a memory, a chipset and various I/O devices.

The second system 10B is a sub-system for causing the storage device 11 to function as a network drive (also referred to as “network storage”) which is accessible from external devices on a network such as a LAN. The second system 10B is configured to operate independently from the first system 10A. The second system 10B has a file system which manages files stored in the storage device 11. The second system 10B executes a file server process in order to enable the storage device 11 to function as a network drive such as a NAS (Network-Attached Storage). The file server process is a process for managing files stored in the storage device 11, and executing write of a file in the storage device 11 or read-out of a file from the storage device 11 in accordance with a file access request which is sent from an external device via the network.

Communication between the second system 10B and the external device on the network is executed by using a network protocol such as NFS (Network File System) or CIFS (Common Internet File System).

As described above, the computer 10 is additionally provided with the second system 10B for causing the storage device 11, which is built in the computer 10, to function as a network drive such as a NAS. By the second system 10B, the storage device 11 can be made to function as a network drive such as a NAS, without booting an operating system which is installed in the storage device 11, that is, without activating the first system 10A that is the main system for executing the information process. Thereby, without causing useless power consumption, the storage device 11, which is built in the computer 10, can be used also as a network drive.

In addition, since the second system 10B can operate independently, even if the operating system becomes unbootable, the storage device 11 can be accessed from a device on the network, and thereby necessary data, such as a file, can be read from the storage device 11. Furthermore, since the second system 10B can be made to function as an intelligent file server, the second system 10B can execute an access authentication process for conforming whether an external device has an access right to the storage device 11 or individual files in the storage device 11. Therefore, a file access control with high security can be realized.

The second system 10B can be built in the body of the computer 10. Needless to say, the second system 10B may be realized as an expansion device which is detachably attached to the body of the computer 10.

The storage device 11 is composed, for example, of a hard disk drive (HDD), or a semiconductor disk drive including a nonvolatile semiconductor memory, which is called “solid-state drive (SSD)”.

The computer 10 has two operation modes, namely, a first mode and a second mode. The first mode is an operation mode (PC mode) in which the storage device 11 is used for the above-described information process. In the first mode (PC mode), the first system 10A is activated, and the storage device 11 is used by the first system 10A. In other words, the first mode (PC mode) is a mode in which the storage device 11 is used as a secondary storage of the computer 10.

The second mode is an operation mode (NAS mode) for using the storage device 11 for the above-described file server process. In the second mode (NAS mode), the first system 10A is not activated, and only the second system 10B is activated, and the storage device 11 is used by the second system 10B. Specifically, the second mode (NAS mode) is a mode in which the computer 10 operations as a dedicated file server, and the storage device 11 is used as a network drive. In the second mode (NAS mode), the operating system of the first system 10A is not booted, and the second system 10B operates independently.

In an ordinary computer, a storage device, such as an HDD, is directly connected to a system via a signal line according to, e.g. parallel ATA (PATA) or serial ATA (SATA) standards. In the present embodiment, in order to share the storage device 11 between the first system.10A and second system 10B, the switch circuit 12 is disposed between each of the first system 10A and second system 10B, and the storage device 11. The switch circuit 12 functions as a switch (HDD switch) which switches the destination of connection of the storage device 11 between the first system 10A and second system 10B. Specifically, in the first mode (PC mode), the switch circuit 12 connects the storage device 11 to the first system 10A. On the other hand, in the second mode (NAS mode), the switch circuit 12 connects the storage device 11 to the second system 10B.

The network connector 13 is a LAN connector of, e.g. RJ45 standard, for connection to a network such as a LAN. In an ordinary computer, the LAN connector is directly connected to the system via a signal line for LAN connection. In the present embodiment, in order to share the network connector 13 between the first system 10A and second system 10B, the switch circuit 14 is disposed between each of the first system 10A and second system 10B, and the network connector 13. The switch circuit 14 functions as a switch (RJ45 switch) which switches the destination of connection of the network connector 13 between the first system 10A and second system 10B. Specifically, in the first mode (PC mode), the switch circuit 14 connects the first system 10A to the network connector 13. On the other hand, in the second mode (NAS mode), the switch circuit 14 connects the second system 10B to the network connector 13.

Instead of providing the switch circuit 14, a signal line for LAN, which is led out from the second system 10B may be connected in a wired-OR form to a signal line for LAN, which connects the first system 10A and the network connector 13. It is not always necessary to share the network connector 13 between the first system 10A and second system 10B. It is possible to provide a network connector which is connected to the first system 10A, and a network connector which is connected to the second system 10B.

The activation control module 15 executes an activation control process for selectively activating one of the first system 10A and second system 10B. Specifically, in the first mode (PC mode), the activation control module 15 activates only the first system 10A. The second system 10B is not activated and is kept in a non-operative state (e.g. power-off state). On the other hand, in the second mode (NAS mode), the activation control module 15 activates the second system 10B. The first system 10A is not activated and is kept in a non-operative state (e.g. power-off state)

The power-off state of the first system 10A includes a suspend state and a hibernation state. Specifically, the first system 10A supports four system states S0, S3, S4 and S5, which are specified by the ACPI (Advanced Configuration and Power Interface) standard. S0 is an operation state in which the first system 10A is powered on. In S0, the first system 10A operates under the control of the operating system. S3 (suspend), S4 (hibernation) and S5 (off) are states in which the first system 10A is powered off. In S3, S4 or S5, the first system IDA does not operate.

In the second mode (NAS mode), the first system 10A is set in the non-operative state (S3, S4 or S5).

The user can designate, for example, by a keyboard operation, in which of the first mode (PC mode) and the second mode (NAS mode) the computer 10 is to be operated. For example, when the computer 10 is powered on in the state in which the first mode (PC mode) is designated by the user, the activation control module 15 activates the first system 10A. On the other hand, when the computer 10 is powered on in the state in which the second mode (NAS mode) is designated by the user, the activation control module 15 activates the second system 10B.

The activation control module 15 also has a function of automatically switching the operation mode of the computer 10 between the first mode (PC mode) and the second mode (NAS mode). Specifically, when a power switch which is provided on the computer 10 is turned on, that is, when power-on of the computer 10 is instructed, the activation control module 15 automatically selects the first mode (PC mode) and activates the first system 10A.

When the power switch provided on the computer 10 is turned off, that is, shut-down of the computer 10 is instructed, the activation control module 15 selects the second mode (NAS mode) on condition that the use of the second mode (NAS mode) is permitted in advance by the user, and activates the second system 10B after setting the first system 10A in the non-operative state.

When the power switch is turned on in the state in which the computer 10 operates in the second mode (NAS mode), that is, power-on of the computer 10 is instructed in the state in which the computer 10 operates in the second mode (NAS mode), the activation control module 15 switches the operation mode of the computer 10 from the second mode (NAS mode) to the first mode (PC mode). In this case, the activation control module 15 activates the first system 10A after setting the second system 10B in the non-operative state.

Also in the first mode (PC mode), with the use of the file sharing function of the operating system, write/read of a file in/from the storage device 11 of the computer 10 can be executed from the external device on the network.

Next, examples of the structures of the first system 10A, second system 10B and activation control module 15 are described.

The first system 10A includes a CPU 111, a north bridge 112, a memory 113, a graphics processing unit (GPU) 114, a display device 115, a south bridge 116 and various I/O devices 117.

The second system 10B includes a storage controller 301.

The activation control module 15 includes a BIOS-ROM 118 and an embedded controller/keyboard controller IC (EC/KBC) 119.

The CPU 111 is a processor which controls the operation of the first system 10A of the computer 10. The CPU 111 executes an operating system (OS) and various application programs, which are loaded from the storage device 11 into the memory 113. Under the control of the operating system (OS), the CPU 111 also executes a process of controlling a network interface module 201 in the south bridge 116, thereby executing communication with a network such as a LAN. In addition, under the control of the operating system (OS), the CPU 111 also executes a process of controlling a storage interface module 202 in the south bridge 116, thereby accessing the storage device 11.

In addition, the CPU 111 executes a BIOS (Basic Input/Output System) that is stored in the BIOS-ROM 118. The BIOS is a program for hardware control.

The north bridge 112 is a bridge device which connects a local bus of the CPU 111 and the south bridge 116. The north bridge 112 includes a memory controller that access-controls the memory 113. The north bridge 112 also has a function of executing communication with the GPU 114 via, e.g. a PCI EXPRESS serial bus.

The GPU 114 is a display controller for controlling the display device 115 that is used as a display monitor of the computer 10. Under the control of the CPU 111, the GPU 114 executes, for example, a rendering process for generating a screen image which is to be displayed on a display screen of the display device 115.

The south bridge 116 executes communication with I/O devices (PCI devices) 117 on a PCI (Peripheral Component Interconnect) bus. In addition, the south bridge 16 is connected to an LPC (Low Pin Count) bus.

The south bridge 116 includes the above-described network interface module 201 and the storage interface module 202. The network interface module 201 is a network controller (LAN controller) which executes communication with the network under the control of the CPU 111. The network interface module 201 is connected to the network connector 13 via the switch circuit 14. The storage interface module 202 executes access to the storage device 11 under the control of the CPU 111. The storage interface module 202 is composed of, e.g. an IDE (Integrated Drive Electronics) controller. The storage interface module 202 is connected to the storage device 11 via the switch circuit 12.

As has been described above, the second system 10B is composed of the storage controller 301. The storage controller 301 is a NAS interface module for executing the above-described file server process. The storage controller 301 is realized, for example, by a microcomputer which is dedicated to the file server process, and the power consumption of the storage controller 301 is much lower than that of the first system 10A. The storage controller 301 includes, for example, a network interface module which executes communication with a network; a storage interface module for accessing the storage device 11; a nonvolatile memory which stores a program; and a processor (MPU) which executes the above-described file server process by executing the program stored in the nonvolatile memory. The network interface module in the storage controller 301 is connected via the switch circuit 14 to the network connector 13, or connected directly to the network connector 13. The storage interface module in the storage controller 301 is connected to the storage device 11 via the switch circuit 12.

The EC/KBC 119 and the BIOS stored in the BIOS-ROM 118 function as the activation control module 15.

The EC/KBC 119 is a 1-chip microcomputer in which an embedded controller for power management and a keyboard controller for controlling the keyboard 122 and touch pad 123 are integrated. Under the control of, e.g. the BIOS, the EC/KBC 119 executes a process for setting the operation mode of the computer 10 to one of the first mode (PC mode) and the second mode (NAS mode). In addition, the EC/KBC 119 has a function of supplying switch control signals (CONT) to the switch circuits 12 and 14. Under the control of the EC/KBC 119, a power supply circuit 120 controls operation power supply to the first system 10A and second system 10B.

The EC/KBC 119 and the storage controller 301 may be connected by a signal line such as a serial bus. In this case, the EC/KBC 119 can inform the storage controller 301 of, for example, the end of the second mode (NAS mode), by executing communication with the storage controller 301.

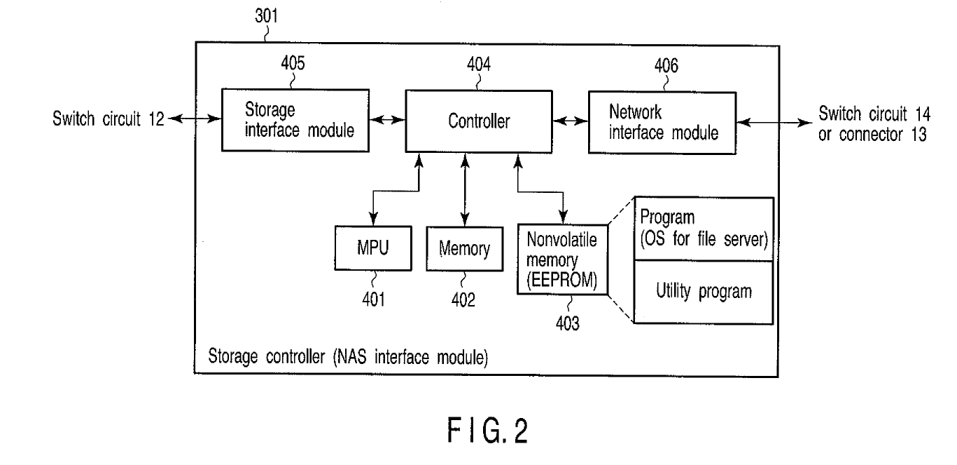

FIG. 2 shows a structure example of the storage controller 301.

The storage controller 301 includes an MPU 401, a memory 402, a nonvolatile memory 403 such as an EEPROM, a controller 404, a storage interface module 405 and a network interface module 406.

The MPU 401 is a processor which executes a program stored in the nonvolatile memory 403. The program stored in the nonvolatile memory 403 is a kind of purpose-specific operating system for executing the file server process. In order to execute the file server process, this program includes a file management function, a network communication function, and a security function including an access authentication function. The controller 404 functions as a bus bridge and interconnects the respective module s in the storage controller 301. Under the control of the MPU 401, the storage interface module 405 executes access to the storage device 11. The storage interface module 405 is composed of, e.g. an IDE (Integrated Drive Electronics) controller. The network interface module 406 is a network controller (LAN controller) which executes communication with the network under the control of the MPU 401.

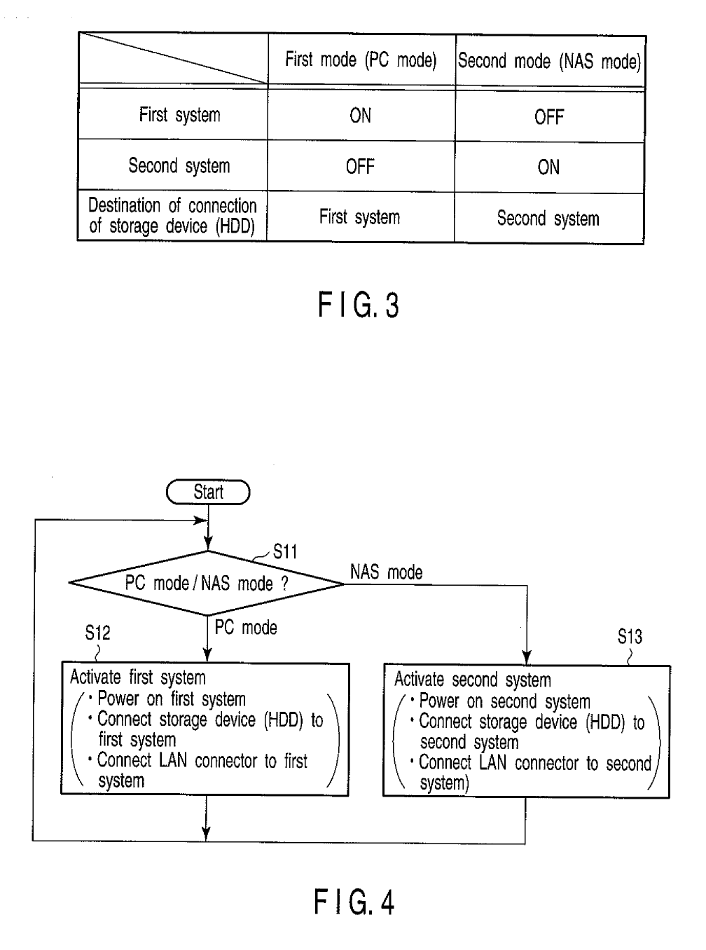

FIG. 3 shows the relationship between the two operation modes of the computer 10 and the states of the two systems 10A and 10B.

In the case where the operation mode of the computer 10 is set in the first mode (PC mode), only the first system 10A is set in the operative state (ON), and the second system 10B is set in the non-operative state (OFF). The storage device 11 is connected to the first system 10A by the switch circuit 12.

In the case where the operation mode of the computer 10 is set in the second mode (NAS mode), only the second system 10B is set in the operative state (ON), and the first system 10A is set in the non-operative state (OFF). In this case, the storage device 11 is connected to the second system 10B by the switch circuit 12.

Next, referring to a flow chart of FIG. 4, a description is given of the procedure of the activation control process which is executed by the activation control module 15.

For example, when an event (power event) for powering on/off the computer 10 has occurred, or when an event (mode change event), which positively indicates a mode change, has occurred by an operation of, e.g. the keyboard 122 by the user, the EC/KBC 119 cooperates with the BIOS and determines whether the operation mode, in which the computer 10 is to be set, is the first mode (PC mode) or the second mode (NAS mode) (block S11).

If the operation mode, in which the computer 10 is to be set, is the first mode (PC mode), the EC/KBC 119 cooperates with the BIOS and activates the first system 10A (block S12). In block S12, the EC/KBC 119 supplies operation power to the first system 10A by using the power supply circuit 120, thereby powering on the first system 10A. In addition, the EC/KBC 119 controls the switch circuit 12 and connects the storage device 11 to the storage interface module 202 in the first system 10A. Further, the EC/KBC 119 controls the switch circuit 14 and connects the network interface module 201 in the first system 10A to the network connector 13. Then, under the control of the BIOS, a process of booting the operating system from the storage device 11 or a resume process for restoring the first system 10A from S3 or S4 to S0 is executed,

If the operation mode, in which the computer 10 is to be set, is the second mode (NAS mode), the EC/KBC 119 cooperates with the BIOS and activates the second system 10B (block S13). In block S13, the EC/KBC 119 supplies operation power to the second system 10B by using the power supply circuit 120, thereby powering on the second system 10B. In addition, the EC/KBC 119 controls the switch circuit 12 and connects the storage device 11 to the second system 10B. Further, the EC/KBC 119 controls the switch circuit 14 and connects the network interface module 406 in the second system 10B to the connector 13.

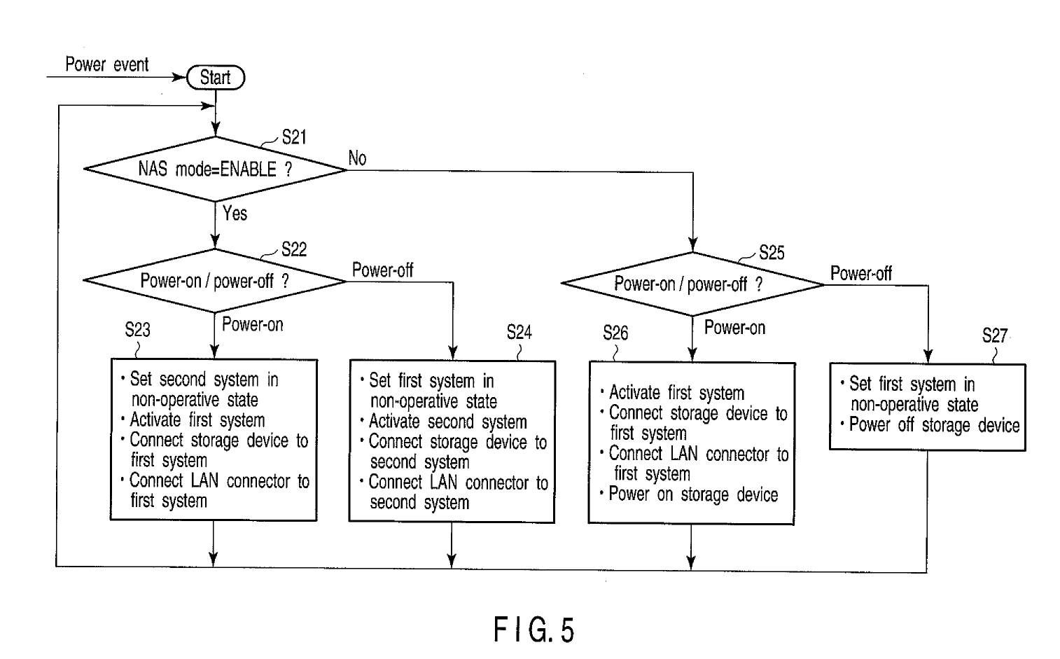

Next, referring to a flow chart of FIG. 5, a description is given of the procedure of a process for automatically switching the operation mode in response to the user's operation of a power switch 121.

The user can designate whether or not to permit the use of the second mode (NAS mode), by using a BIOS setup function. System configuration information, which is indicative of whether the use of the second mode (NAS mode) is permitted or not, is stored in the BIOS-ROM 118 or a CMOS memory, together with information indicative of setup contents relating to other various devices.

When an event (power event) for powering on/off the computer 10 has occurred by the user's operation of the power switch 121, the EC/KBC 119 first refers to the system configuration information, and determines whether the use of the second mode (NAS mode) is permitted or not, that is, whether the NAS mode is enabled (NAS mode=enable) or not (block S21).

If “NAS mode=enable” (YES in block S21), the EC/KBC 119 determines whether the power event, which has occurred, instructs power-on or power-off, that is, whether the operation of the power switch 121 is a power-on operation or a power-off operation (block S22).

If the operation of the power switch 121 is the power-on operation, the EC/KBC 119 transitions to a process of block S23.

In block S23, the EC/KBC 119 sets the second system 10B, that is, the storage controller 301, in the non-operative state. In this case, the EC/KBC 119 may inform the storage controller 301 that the operation of the storage controller 301 is to be stopped, before the EC/KBC 119 powers off the storage controller 301. Responding to this information, the storage controller 301 executes a finishing process. In this finishing process, the storage controller 301 also executes a process of informing, for example, the external device on the network, which uses the storage device 11, that the file server process is to be finished. After the finishing process of the storage controller 301 is completed, the EC/KBC 119 powers on the first system 10A, and cooperates with the BIOS and activates the first system 10A. Further, the EC/KBC 119 controls the switch circuit 12 and connects the storage device 11 to the first system 10A, and controls the switch circuit 14 and connects the first system 10A to the connector 13.

If the operation of the power switch 121 is the power-off operation, the EC/KBC 119 transitions to a process of block S24.

In block S24, the EC/KBC 119 cooperates with the BIOS and sets the first system 10A in the non-operative state. Then, the EC/KBC 119 powers on the second system 10B, that is, the storage controller 301, and activates the storage controller 301. Further, the EC/KBC 119 controls the switch circuit 12 and connects the storage device 11 to the storage controller 301, and controls the switch circuit 14 and connects the storage controller 301 to the connector 13.

If the NAS mode is not enabled, that is, if the use of the NAS mode is not permitted by the user (NO in block S21), the EC/KBC 119 goes to a process of block S25, and determines whether the power event, which has occurred, instructs power-on or power-off, that is, whether the operation of the power switch 121 is a power-on operation or a power-off operation (block S25).

If the operation of the power switch 121 is the power-on operation, the EC/KBC 119 transitions to a process of block S26.

In block S26, the EC/KBC 119 powers on the first system 10A, and cooperates with the BIOS and activates the first system 10A. Then, the EC/KBC 119 controls the switch circuit 12 and connects the storage device 11 to the first system 10A, and controls the switch circuit 14 and connects the first system 10A to the connector 13. Further, the EC/KBC 119 supplies operation power to the storage device 11 by using the power supply circuit 120, thereby powering on the storage device 11.

If the operation of the power switch 121 is the power-off operation, the EC/KBC 119 transitions to a process of block S27.

In block S27, the EC/KEC 119 sets the first system 10A in the non-operative state so that both the first system 10A and the second system 10B are set in the non-operative state. Further, the EC/KBC 119 executes a process of powering off the storage device 11.

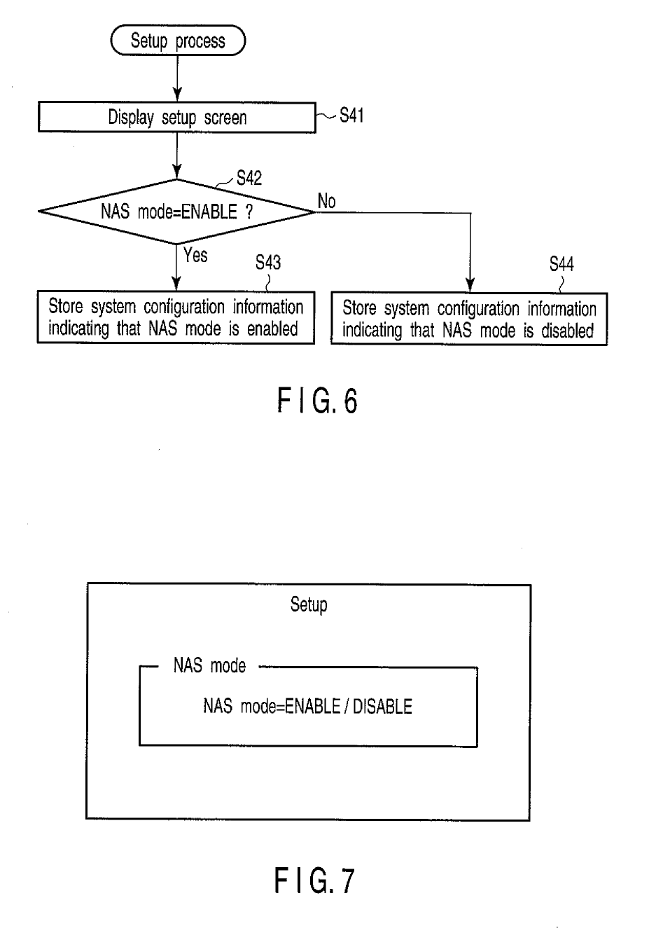

Next, referring to a flow chart of FIG. 6, a description is given of the procedure of a setup process which is executed by the BIOS.

This setup process is a process for prompting the user to designate an operational environment of the computer 10.

For example, if the computer 10 is powered on in the state in which a predetermined key is pressed by the user, the BIOS displays, on the display screen of the display device 115, a setup screen for prompting the user to set the operational environment of the computer 10 (block S41). The setup screen, as shown in FIG. 7, also displays an item for prompting the user to designate whether or not to permit the use of the NAS mode.

It “NAS MODE=ENABLE” is selected by the operation of the keyboard by the user (YES in block S42), the BIOS stores, in the BIOS-ROM 118 or CMOS memory, system configuration information which indicates that the use of the NAS mode is enabled, that is, thae use of the NAS mode is permitted (block S43).

If “NAS MODE=DISABLE” is selected by the operation of the keyboard by the user (NO in block S42), the BIOS stores, in the BIOS-ROM 118 or CMOS memory, system configuration information which indicates that the use of the NAS mode is disabled, that is, the use of the NAS mode is not permitted (block S44).

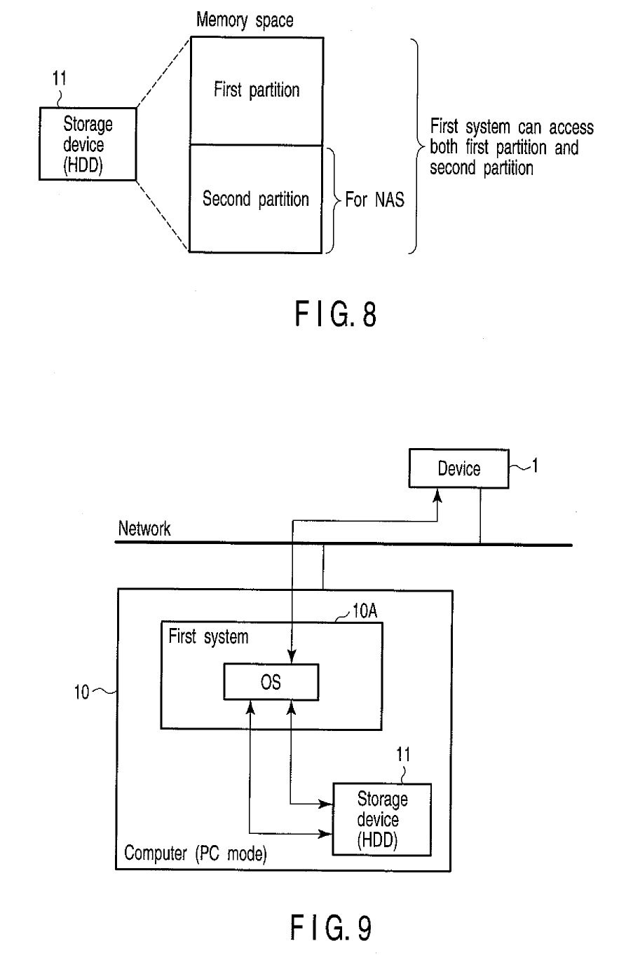

FIG. 8 shows an example of use of the memory space of the storage device 11.

In FIG. 8, the memory space of the storage device 11 is divided into a first partition and a second partition. The first partition is a memory area for the first mode (PC mode). The operating system manages the first partition, and executes write of a file in the first partition and read-out of a file from the first partition. The second partition is a memory area for the second mode (NAS mode). The storage controller 301 manages the second partition, and executes write of a file in the second partition and read-out of a file from the second partition, in accordance with a file access request from the external device on the network.

The operating system can also access the second partition. Whether or not to permit the storage controller 301 to access the first partition can be set by using the security function of the storage controller 301.

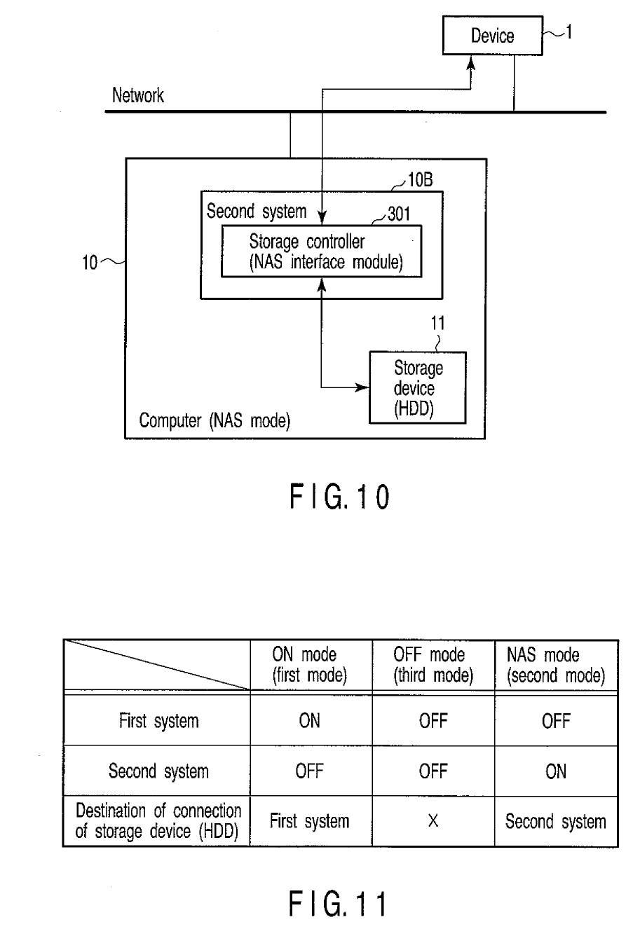

Next, referring to FIG. 9 and FIG. 10, a description is given of the file access process in each of the first mode (PC mode) and the second mode (NAS mode).

FIG. 9 shows the file access process in the first mode (PC mode). In the first mode (PC mode), the operating system of the first system 10A executes write of a file in the storage device 11 and read-out of a file from the storage device 11, in accordance with a file access request from the application program, etc. In addition, since the operating system has the file sharing function, the operating system can also execute write of a file in the storage device 11 and read-out of a file from the storage device 11, in accordance with a file access request from an external device 1 on the network.

FIG. 10 shows the file access process in the second mode (NAS mode). In the second mode (NAS mode) not the first system 10A but the storage controller 301 of the second system 10B operates. The storage controller 301 executes write of a file in the storage device 11 and read-out of a file from the storage device 11, in accordance with a file access request from the external device 1 on the network.

In the computer 10, a third mode (OFF mode) can be defined in addition to the first mode (PC mode) and the second mode (NAS mode) For example, the power switch 121 may be a slide switch which has three switch positions corresponding to the first mode (PC mode), second mode (NAS mode) and third mode (OFF mode). In this case, if the switch position of the power switch 121 is shifted from the switch position corresponding to the OFF mode to the switch position corresponding to the PC mode, the computer 10 is activated in the PC mode. If the switch position of the power switch 121 is shifted from the switch position corresponding to the OFF mode to the switch position corresponding to the NAS mode, the computer 10 is activated in the NAS mode.

Alternatively, the computer 10 may be provided with two power switches including a power switch which instructs the ON/OFF of the first mode (PC mode), and a power switch which instructs the ON/OFF of the second mode (NAS mode).

Alternatively, the computer 10 may be configured to be activated in the NAS mode when the power switch 121 is turned on in the state in which a specific key on the keyboard is pressed, and to be activated in the PC mode when the power switch 121 is turned on in the state in which the specific key on the keyboard is not pressed. Furthermore, it may be determined whether the power switch 121 is continuously pressed for a predetermined time period or more (long-time pressing), and the computer 10 may be configured to be activated in the NAS mode in the case of the long-time pressing, and to be activated in the PC mode not in the case of the long-time pressing. No matter whether the computer 10 is activated in the PC mode or the NAS mode, if the power switch 121 is turned off, the computer 10 is set in the OFF mode in which both the first system 10A and the second system 10B are rendered non-operative.

FIG. 11 shows the relationship between the three modes (PC mode, NAS mode OFF mode) of the computer 10 and the states of the two systems 10A and 10B.

In the case where the computer 10 is set in the first mode (PC mode), only the first system 10A is set in the operative state (ON), and the second system 10B is set in the non-operative state (OFF). In this case, the storage device 11 is connected to the first system 10A by the switch circuit 12.

In the case where the computer 10 is set in the third mode (OFF mode), each of the first system 10A and the second system 10B is set in the non-operative state (OFF).

In the case where the operation mode of the computer 10 is set in the second mode (NAS mode), only the second system 10B is set in the operative state (ON), and the first system 10A is set in the non-operative state (OFF). In this case, the storage device 11 is connected to the second system 10B by the switch circuit 12.

Next, a description is given of a system configuration in a case where the second system 10B is realized by an expansion device which is detachably attached to the computer 10.

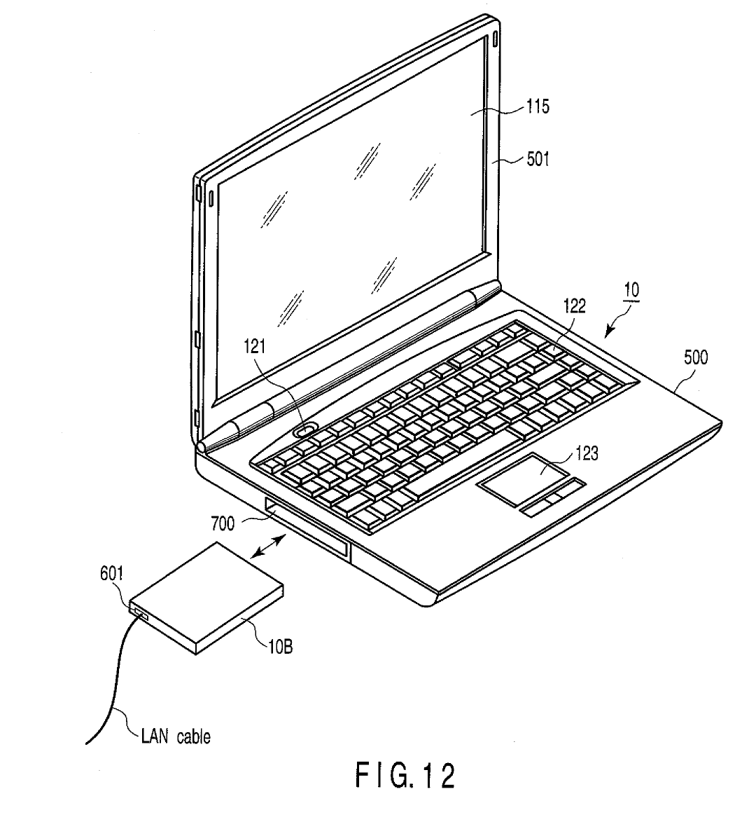

FIG. 12 is a perspective view of the computer 10 which is configured such that an expansion device can be attached.

The computer 10 is composed of a computer main body 500 and a display module 501. A display device 115, which is composed of, e.g. a TFT-LCD (Thin-Film Transistor Liquid Crystal Display), is built in the display module 501.

The display module 501 is attached to the computer main body 500 such that the display module 501 is rotatable between an open position where the top surface of the computer main body 500 is exposed, and a closed position where the top surface of the computer main body 500 is covered. The computer main body 500 has a thin box-shaped casing. A keyboard 122, a power switch 121 for powering on/off the computer 10 and a touch pad 123 are disposed on the top surface of the computer main body 500.

A slot 700 for attaching an expansion device to the computer main body 500 is provided, for example, on a side surface of the computer main body 500.

The second system 10B is realized as an expansion device which is detachably inserted in the slot 700. The above-described storage controller 301 is built in the casing of the second system 10B. A network connector 601 is provided on the front surface of the casing of the second system 10B.

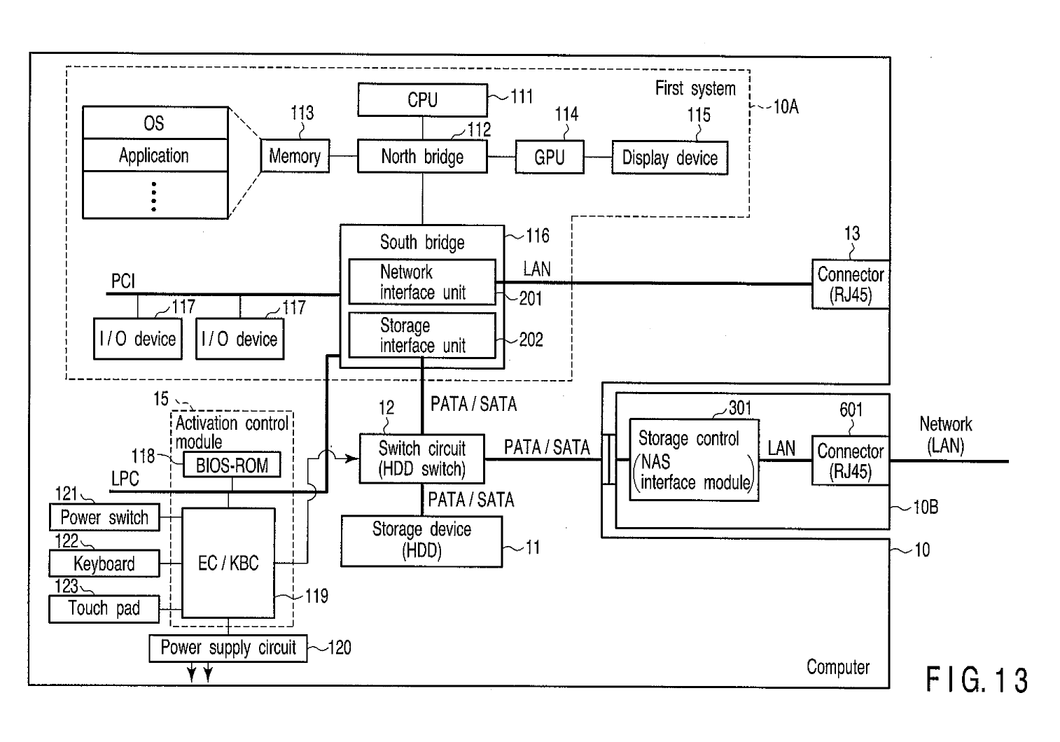

FIG. 13 shows an example of the system configuration in which the second system 10B is attached.

In the state in which the casing of the second system 10B is inserted in the slot 700, the storage controller 301 is connected to the switch circuit 12 via a connector which is provided on a back surface of the casing of the second system 10B.

As has been described above, in the computer 10 of the present embodiment, the second system 10B, which functions as a file server, is provided. In the NAS mode, only the second system 10B operates, and the first system 10A does not operate. Thus, without booting the operating system, the storage device 11, which is built in the computer 10, can be made to function as a NAS. Therefore, the storage device 11, which is built in the computer 10, can be used as a network drive such as a NAS, without causing useless power consumption.

In the NAS mode, the storage device 11 can be used as if it were a storage that is directly connected to a network. Accordingly, the storage device 11, which is built in the computer 10, can easily be accessed from various devices (TV, other computers) on the network. Thus, the TV, etc. can easily read files from the storage device 11, and can use the files. Therefore, for example, in the case where an audio/video file, or the like, which is downloaded from a site on the Internet, is stored in the storage device 11 of the computer 10, the TV can read the audio/video file from the storage device 11 and can play back the audio/video file. Besides, received broadcast program data can be stored in the storage device 11 of the computer 10.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage device;
a first processing module configured to execute an information process which comprises at least a process of accessing the storage device, a process of executing an application program stored in the storage device, or a process of executing communication with a network, under control of an operating system configured to manage files stored in the storage device;
a second processing module configured to operate independently from the first processing module, and to execute a file server process of managing the files stored in the storage device and either writing a file in the storage device or reading out a file from the storage device in response to a file access request sent from an external device via the network;
an activation controller configured to activate the first processing module in a first mode in which the storage device is used for the information process, and to activate the second processing module in a second mode in which the storage device is used for the file server process; and
a switch circuit among the first processing module, the second processing module and the storage device, configured to connect the storage device to the first processing module in the first mode, and to connect the storage device to the second processing module in the second mode.

2. The information processing apparatus of claim 1, wherein the first processing module is kept in a non-operative state in the second mode and the second processing module is kept in a non-operative state in the first mode.

3. The information processing apparatus of claim 2, wherein the activation controller is configured to activate the first processing module in response to a turn-on operation of a power switch on the information processing apparatus, and configured to set the first processing module in the non-operative state and to activate the second processing module in response to a turn-off operation of the power switch when the second mode is enabled.

4. The information processing apparatus of claim 3, wherein the activation control module is configured to set the first processing module and the second processing module in the non-operative state in response to the turn-off operation of the power switch, and to turn off the storage device when the second mode is disabled.

5. The information processing apparatus of claim 3, wherein the activation controller is configured to set the second processing module in the non-operative state and to activate the first processing module when the turn-on operation of the power switch is executed while the second processing module is active.

6. The information processing apparatus of claim 1, wherein the second processing module comprises:
a network interface configured to communicate with the network;
a storage interface for accessing the storage device;
a nonvolatile memory configured to store a program; and
a processor configured to execute the file server process by executing the program stored in the nonvolatile memory.

7. The information processing apparatus of claim 1, further comprising a main body configured to comprise the first processing module,
wherein the second processing module is an external device attachable to the main body.

8. A control method for causing an information processing apparatus which comprises a storage device to operate as a file server, the information processing apparatus comprising a first processing module configured to execute an information process which comprises at least a process of accessing the storage device, a process of executing an application program stored in the storage device, or a process of executing communication with a network, under control of an operating system configured to manage files stored in the storage device, and a second processing module configured to operate independently from the first processing module, and to execute a file server process of managing the files stored in the storage device and either writing a file in the storage device or reading out a file from the storage device in response to a file access request sent from an external device via the network, the method comprising:
activating the first processing module in a first mode for executing the information process, and activating the second processing module in a second mode in which the storage device is used for file server process; and
controlling a switch circuit among the first processing module, the second processing module and the storage device, connecting the storage device to the first processing module in the first mode, and connecting the storage device to the second processing module in the second mode.

9. The control method of claim 8, wherein the first processing module is kept in a non-operative state in the second mode and the second processing module is kept in a non-operative state in the first mode.

10. The control method of claim 9, wherein the activation control process comprises:
activating the first processing module in response to a turn-on operation of a power switch on the information processing apparatus; and
setting the first processing module to the non-operative state and activating the second processing module in response to a turn-off operation of the power switch when the second mode is enabled.
